(19) United States
(12) Patent Application Publication
(10) Pub. No.: US 2017/0187824 A1
(43) Pub. Date: Jun. 29, 2017

(54) METHOD, DEVICE, AND COMPUTER-READABLE MEDIUM FOR ACQUIRING USER INFORMATION

(71) Applicant: Xiaomi Inc., Beijing (CN)

(72) Inventors: Xiaoliang ZHANG, Beijing (CN); Hao YAN, Beijing (CN); Jianchun ZHANG, Beijing (CN)

(73) Assignee: Xiaomi Inc.

(21) Appl. No.: 15/380,504

(22) Filed: Dec. 15, 2016

(30) Foreign Application Priority Data
Dec. 28, 2015 (CN) 201511001356.8

(51) Int. Cl. H04L 29/08

(52) U.S. Cl. CPC H04L 67/306; H04L 67/18; H04L 67/10

(57) ABSTRACT

A method for acquiring user information includes obtaining headshot information of a target user. The method also includes acquiring user information of the target user based on the headshot information of the target user and a predefined set of acquisition policies. The predefined set of acquisition policies includes at least one acquisition policy, and each of the acquisition policies indicates a respective approach to acquiring the user information of the target user.

### CROSS-REFERENCE TO RELATED APPLICATION

This application is based upon and claims priority to Chinese Patent Application No. 201511001356.8, filed on Dec. 28, 2015, the entire contents of which are incorporated herein by reference.

### TECHNICAL FIELD

The present disclosure generally relates to communication technologies, and more particularly, to a method, device and computer-readable medium for acquiring user information.

### BACKGROUND

In modern society, changes in economics and society environments make it increasingly important for people to interact with others. Only through continuous interaction and communication with others, can a person constantly enrich his experience. Therefore, it is desirable for a person to continuously expand his contacts and connections.

In related art, when a user A wishes to obtain user information of user B, user A may need to first obtain relevant information (e.g., a name) of user B. Then, user A can acquire other additional information of user B through a network or other channels (e.g., by asking acquaintances about user B) using such relevant information of the user B.

### SUMMARY

According to a first aspect of the present disclosure, there is provided a method for acquiring user information. The method includes obtaining headshot information of a target user. The method also includes acquiring user information of the target user based on the headshot information of the target user and a predefined set of acquisition policies. The predefined set of acquisition policies includes at least one acquisition policy, and each of the acquisition policies indicates a respective approach to acquiring the user information of the target user.

According to a second aspect of the present disclosure, there is provided a device for acquiring user information. The device is a first terminal device and includes a processor and a memory for storing instructions executable by the processor. The processor is configured to execute the instructions to obtain headshot information of a target user. The processor is also configured to execute the instructions to acquire user information of the target user based on the headshot information of the target user and a predefined set of acquisition policies. The predefined set of acquisition policies includes at least one acquisition policy, and each of the acquisition policies indicates a respective approach to acquiring user information of the target user.

It is to be understood that both the forgoing general description and the following detailed description are exemplary only, and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1A shows a flowchart illustrating a method for acquiring user information according to an exemplary embodiment.

FIG. 1B is a schematic diagram illustrating a scenario in which a method of acquiring user information is applied according to an exemplary embodiment.

FIG. 1C is a schematic diagram illustrating an interface displaying the acquired user information of a target user when implementing the exemplary embodiment of FIG. 1A.

FIG. 2A shows a flowchart illustrating another method for acquiring user information according to another exemplary embodiment.

FIGS. 2B-2D are schematic diagrams illustrating interfaces displayed when implementing the exemplary embodiment of FIG. 2A.

FIG. 3A shows a flowchart illustrating another method for acquiring user information according to an exemplary embodiment.

FIGS. 3B-3D are schematic diagrams illustrating interfaces displayed when implementing the exemplary embodiment of FIG. 3A.

FIG. 4 shows a flowchart illustrating another method for acquiring user information according to an exemplary embodiment.

FIG. 5A shows a flowchart illustrating another method for acquiring user information according to an exemplary embodiment.

FIG. 5B is a schematic diagram illustrating an interface displayed when implementing the exemplary embodiment of FIG. 5A.

FIG. 6 is a block diagram of a device for acquiring user information according to an exemplary embodiment.

FIG. 7 is a block diagram of another device for acquiring user information according to another exemplary embodiment.

FIG. 8 is a block diagram of another device for acquiring user information according to another exemplary embodiment.

FIG. 9 is a block diagram of a terminal device according to an exemplary embodiment.

FIG. 10 is a block diagram of a terminal device according to another exemplary embodiment.

FIG. 11 is a block diagram of another device for acquiring user information according to another exemplary embodiment.

FIG. 12 is a block diagram of another device for acquiring user information according to another exemplary embodiment.

FIG. 13 is a block diagram of a server according to an exemplary embodiment.

FIG. 14 is a block diagram of a server according to another exemplary embodiment.

FIG. 15 is a block diagram of another device for acquiring user information according to another exemplary embodiment.

FIG. 16 is a block diagram of another device for acquiring user information according to another exemplary embodiment.

FIG. 17 is a block diagram of another terminal device according to another exemplary embodiment.

With reference to the above drawings, specific embodiments of the present disclosure have been illustrated, which will be described below in more details. Those drawings and literature descriptions are not intended to limit the scope of the invention in any way, but are only intended to illustrate concepts of the disclosure.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of devices and methods consistent with aspects related to the invention as recited in the appended claims.

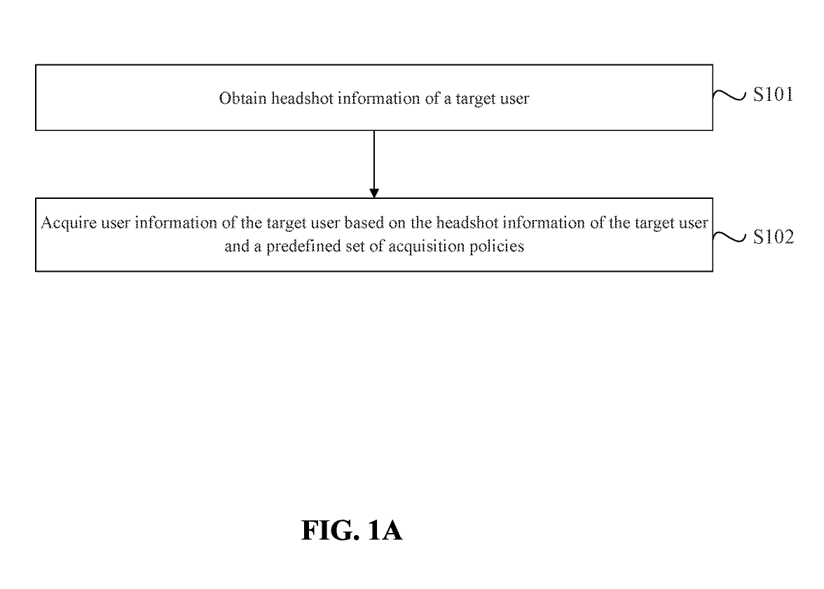

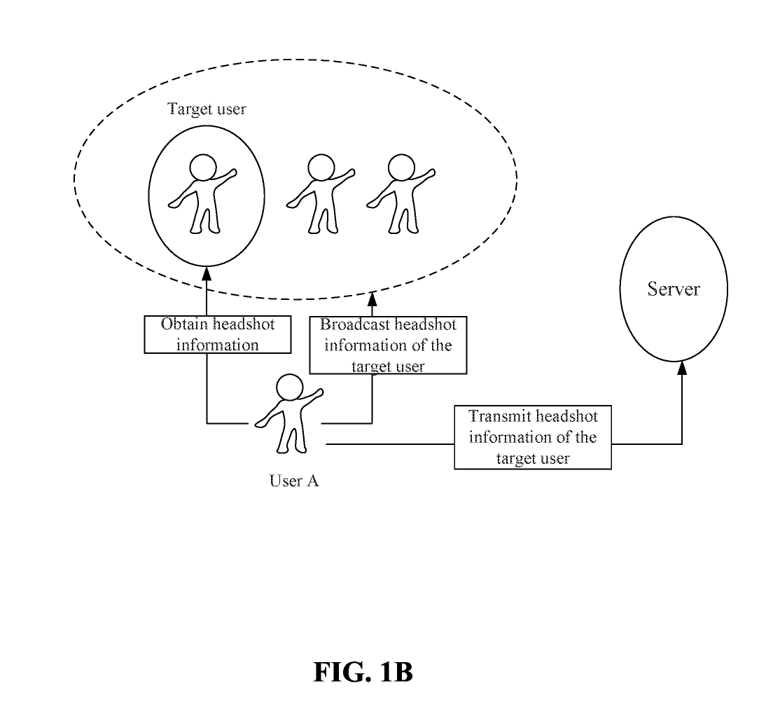

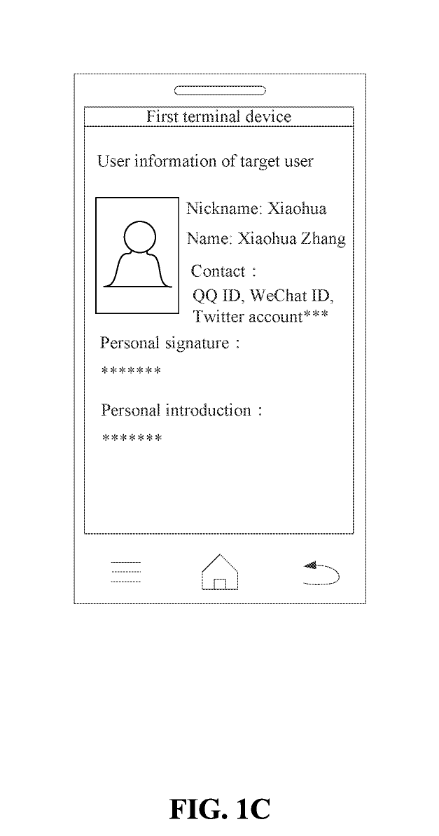

FIG. 1A shows a flowchart illustrating a method for acquiring user information according to an exemplary embodiment. FIG. 1B is a schematic diagram illustrating a scenario in which a method of acquiring user information is applied according to an exemplary embodiment. FIG. 1C is a schematic diagram illustrating an interface displaying the acquired user information of a target user when implementing the exemplary embodiment of FIG. 1A. The user information acquisition method shown in FIG. 1A may be applied in (e.g., performed by) a variety of terminal devices using user recognition software that recognizes a user based on headshot information (hereinafter referred to as “headshot information based user recognition software” or “user recognition software”) to acquire user information of a target user based on the headshot information. The user information acquisition method includes the following steps.

In step S101, headshot information of a target user is obtained.

In this step, optionally, when user A (shown in FIG. 1B) having a terminal device wishes to obtain user information of a target user, user A may operate the terminal device to run the headshot information based user recognition software. The terminal device is pointed at the target user such that headshot information of the target user is acquired with a headshot-capture function of the user recognition software. Optionally, the headshot information of the target user is obtained by a camera of the terminal device. In some embodiments, the headshot information of the target user uniquely identifies the target user. Optionally, after the terminal device is operated to run the headshot information based user recognition software, if user A having the terminal device has also identified the person that he or she wants to meet with (i.e., the target user) through communication software such as WeChat®, QQ®, etc., the terminal device may save the headshot information of the target user (if the target user has disclosed the headshot information in the communication software). Alternatively, the headshot information of the target user may be obtained by other methods, and the present disclosure does not limit the methods through which the headshot information is obtained.

Referring back to FIG. 1A, in step S102, user information of the target user is acquired based on the headshot information of the target user and a predefined set of acquisition policies.

In this step, because the headshot information of the target user uniquely identifies the target user, after obtaining the headshot information of the target user, the terminal device acquires the user information of the target user based on the headshot information of the target user and a predefined set of acquisition policies. The predefined set of acquisition policies includes at least one acquisition policy. Each of the acquisition policies indicates a respective approach to acquiring user information of the target user (e.g., approaches to acquiring user information of the target user based on the headshot information of the target user). In some embodiments, as shown in FIG. 1B, after the terminal device is operated to run the headshot information based user recognition software, based on the headshot information of the target user, the user information of the target user is acquired from a server (e.g., a cloud server) (this approach may be referred as acquisition policy 1). Alternatively, the user information of the target user is acquired by broadcasting the headshot information of the target user within a predefined range (this approach may be referred to as acquisition policy 2). Alternatively, the user information of the target user is acquired through a combination of the above two approaches (this approach may be referred as acquisition policy 3). Optionally, the user information of the target user may be acquired through other methods, which are not limited in the present disclosure.

In some embodiments, as shown in FIG. 1C, the user information acquired in step S102 includes the target user's headshot information and profile information, e.g., the name or nickname of the target user, contact information such as WeChat® account number, QQ® account number, Weibo account number, and other related description information. User A can contact the target user according to the profile information. Although the headshot information of the target user acquired in step S102 may be different from the headshot information obtained in step S101 (for example, in terms of description manners), both of them can uniquely identify the target user. For example, the two pieces of headshot information may be headshot information of the target user captured at different time, but both of them uniquely identify the same target user.

A method of acquiring user information is provided in the present embodiment. With the steps of obtaining the headshot information of a target user, and acquiring the user information of the target user based on the headshot information of the target user and a predefined set of acquisition policies, the user information of the target user can be accurately acquired, thereby improving the user experience.

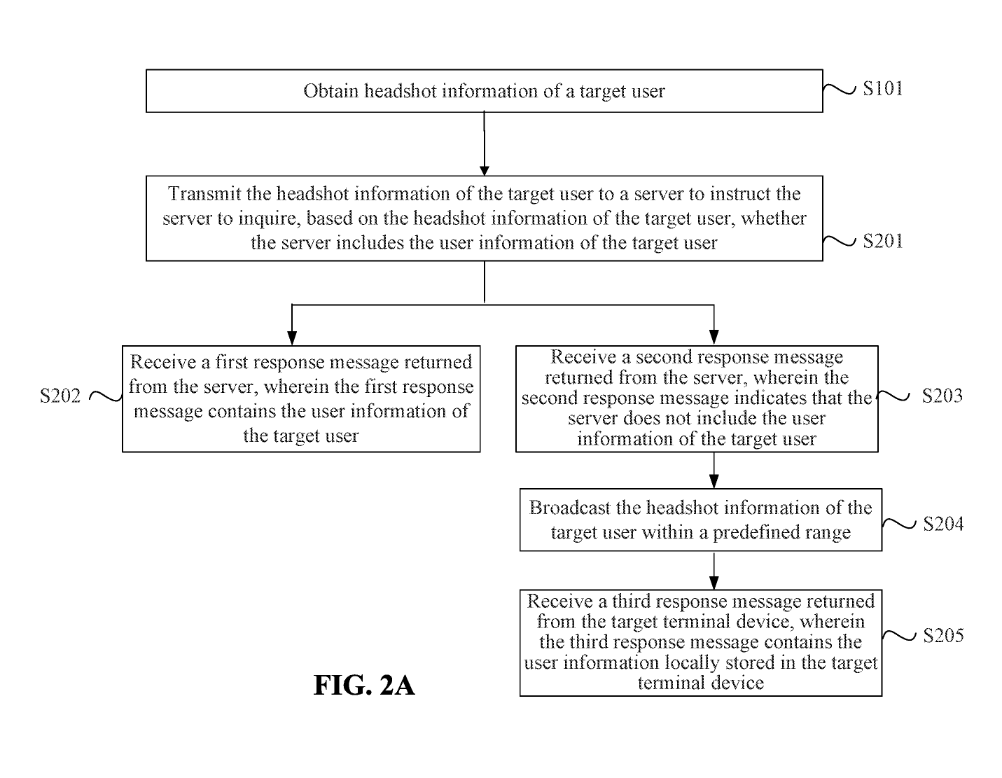

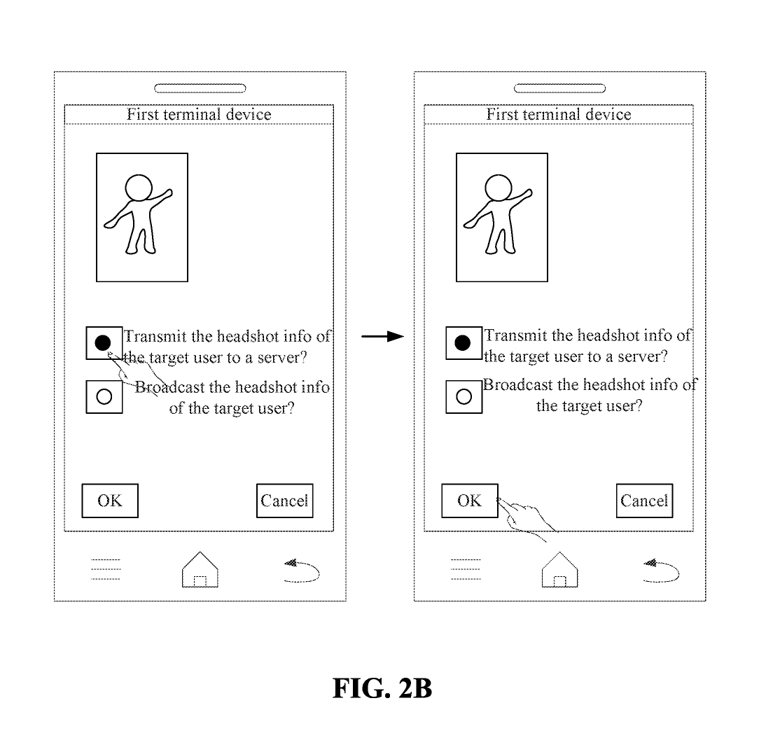

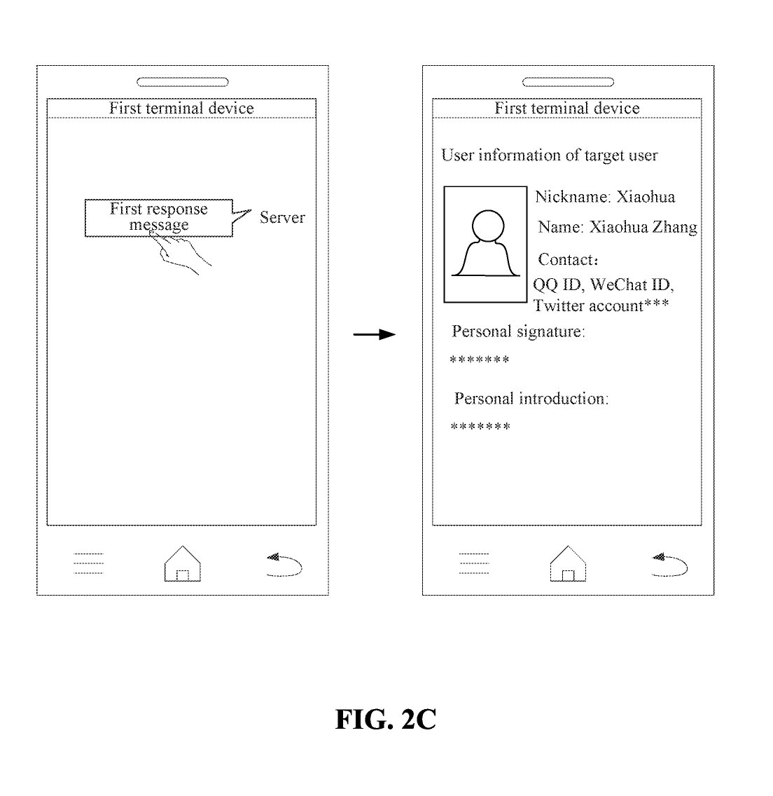

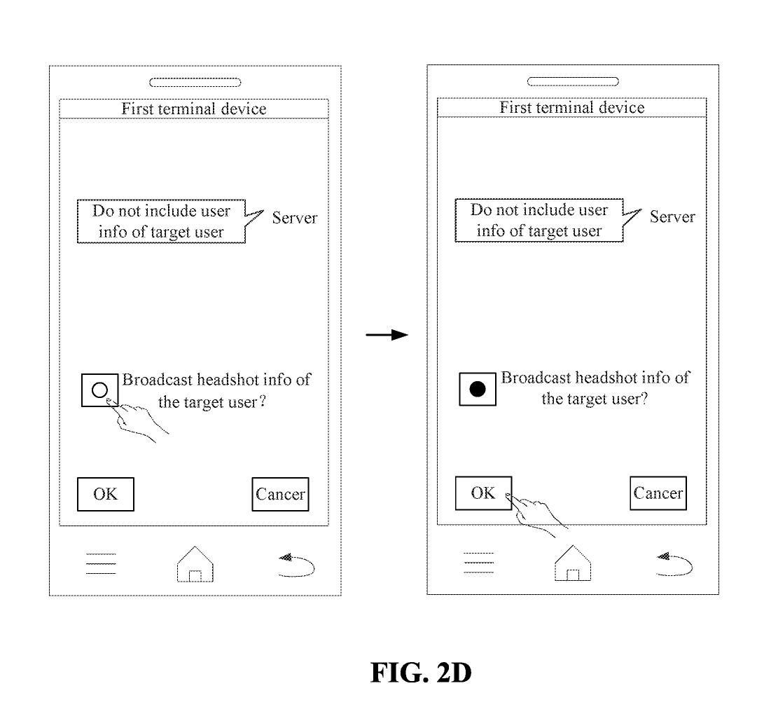

FIG. 2A shows a flowchart illustrating another method for acquiring user information according to another exemplary embodiment. FIGS. 2B-2D are schematic diagrams illustrating interfaces displayed when implementing the exemplary embodiment of FIG. 2A. On the basis of the embodiment described above, as shown in FIG. 2A, the detailed implementation of step S102 further includes the following steps S201-S205.

In step S201, the headshot information of the target user is transmitted to a server to instruct the server to inquire, based on the headshot information of the target user, whether the server includes the user information of the target user.

In some embodiments, the user information includes headshot information and profile information of the target user.

In some embodiments, the server stores the user information of at least one user (e.g., information that is allowed by the user to disclose to others). The stored user information includes headshot information of the user, profile information of the user, and the like. In this step, after the terminal device is operated to run headshot information based user recognition software, the headshot information of the target user obtained in step S101 may be transmitted to the server. For example, as shown in FIG. 2B, the terminal device may display an interface having a selection block of “transmit the headshot info of the target user to a server” for the user to select. Once the terminal device receives a user input selecting this selection block and a user input clicking an “OK” button (shown in FIG. 2B), the terminal device transmits the headshot information of the target user to the server. The headshot information of the target user is used to instruct the server to inquire, based on the headshot information of the target user, whether the server includes the user information of the target user. If the server has stored the user information of the target user, the server transmits a first response message containing the user information of the target user. Correspondingly, the terminal device performs step S202 (discussed below). If the server has not stored the user information of the target user, the server transmits a second response message indicating that the server does not include the user information of the target user. Correspondingly, the terminal device performs step S203 (discussed below).

Referring to FIG. 2A, in step S202 (shown in FIG. 2A), a first response message returned from the server is received by the terminal device. An example first response message is shown in FIG. 2C. As shown in FIG. 2C, the first response message contains the user information of the target user.

Referring to FIG. 2A, in step S203, a second response message returned from the server is received by the terminal device. FIG. 2D shows an exemplary second response message “Do not include user info of target user” displayed on the interface of the terminal device. The second response message indicates that the server does not include the user information of the target user.

In some embodiments, if the terminal device does not acquire user information of the target user from the server, the terminal device may further seek to acquire user information of the target user by broadcasting the headshot information of the target user within a predefined range. For example, as shown in FIG. 2D, the terminal device may display an interface having a selection block of “broadcast the headshot info of the target user” for a user to select. After the terminal device receives a user input selecting this selection block and a user input clicking an “OK” button (shown in FIG. 2D), the terminal device broadcasts the headshot information of the target user.

Referring to FIG. 2A, in step S204, the headshot information of the target user is broadcasted within a predefined range.

In some embodiments, a target terminal device corresponding to the target user is located within the predefined range.

In this step, the terminal device broadcasts the headshot information of the target user within the predefined range (for ease of description, this broadcasting terminal device is referred to as “first terminal device” hereinafter). Optionally, the headshot information based user recognition software includes a broadcast function. In some embodiments, the headshot information of the target user obtained in step S101 may be broadcasted via Bluetooth®, WiFi®, etc. A terminal device capable of receiving the headshot information of the target user within the predefined range (for ease of description, this receiving terminal device is referred to as “second terminal device” hereinafter) may determine whether the second terminal device is the target terminal device corresponding to the target user based on the headshot information of the target user and headshot information stored in the second terminal device. The stored headshot information may uniquely identify a user having the second terminal device. For example, in some embodiments, the second terminal device determines whether the headshot information of the target user and headshot information stored in the second terminal device identify the same user. If the headshot information of the target user and headshot information stored in the second terminal device identify the same user (i.e., the second terminal device is the target terminal device), a third response message containing the user information locally stored in the target terminal device (e.g., the user information of the target user) is transmitted to the first terminal device. Correspondingly, the first terminal device performs step S205 (discussed below).

In some embodiments, the second terminal device may be preconfigured to be allowed to respond to other terminal devices with user information of a user of the second terminal device (e.g., a user having the second terminal device). For example, in some embodiments, when the first terminal device transmits to the second terminal device headshot information of the user of the second terminal device, the second terminal device automatically returns to the first terminal device a response message containing the user information of the user of the second terminal device. In an alternative embodiment, before the second terminal device transmits the third response message to the first terminal device, the second terminal device informs its user of the following: a request transmitted from the first terminal device requests to acquire the user information of the user, is it allowable to transmit the user information to the first terminal device? If the user allows the second terminal device to transmit the user information to the first terminal device, the second terminal device transmits the third response message to the first terminal device. If the user refuses or declines to transmit the user information to the first terminal device, the second terminal device transmits to the first terminal device a fourth response message, which indicates that the user of the second terminal device (i.e., the target device) declines to transmit the user information to the first terminal device.

In some embodiments, if the headshot information of the target user and the headshot information stored in the second terminal device identify two different users (i.e., the second terminal device is not the target terminal device), the second terminal device does not transmit any response message to the first terminal device.

Referring to FIG. 2A, in step S205, the third response message returned from the target terminal device is received. The third response message contains the user information locally stored in the target terminal device.

In some embodiments, if the user information of the target user acquired by the first terminal device from the server does not have sufficient information content, the first terminal device further broadcasts the headshot information of the target user within a predefined range so as to acquire additional user information of the target user. The details about the broadcasting have been described above with respect to step S204, which are not repeated.

In some embodiments, the headshot information of the target user obtained in step S101 is encrypted to generate the encrypted headshot information of the target user. In step S201, encrypted headshot information of the target user is transmitted to the server, such that the server inquires whether the server includes the user information of the target user in accordance with decrypted headshot information. Optionally, in step S204, the encrypted headshot information of the target user is broadcasted within the predefined range.

Methods of acquiring user information are provided in the present disclosure. By combining a method of acquiring the user information of the target user from the server and a method of broadcasting the headshot information of the target user so as to acquire the user information of the target user, the user information of the target user can be accurately acquired, thereby improving the user experience.

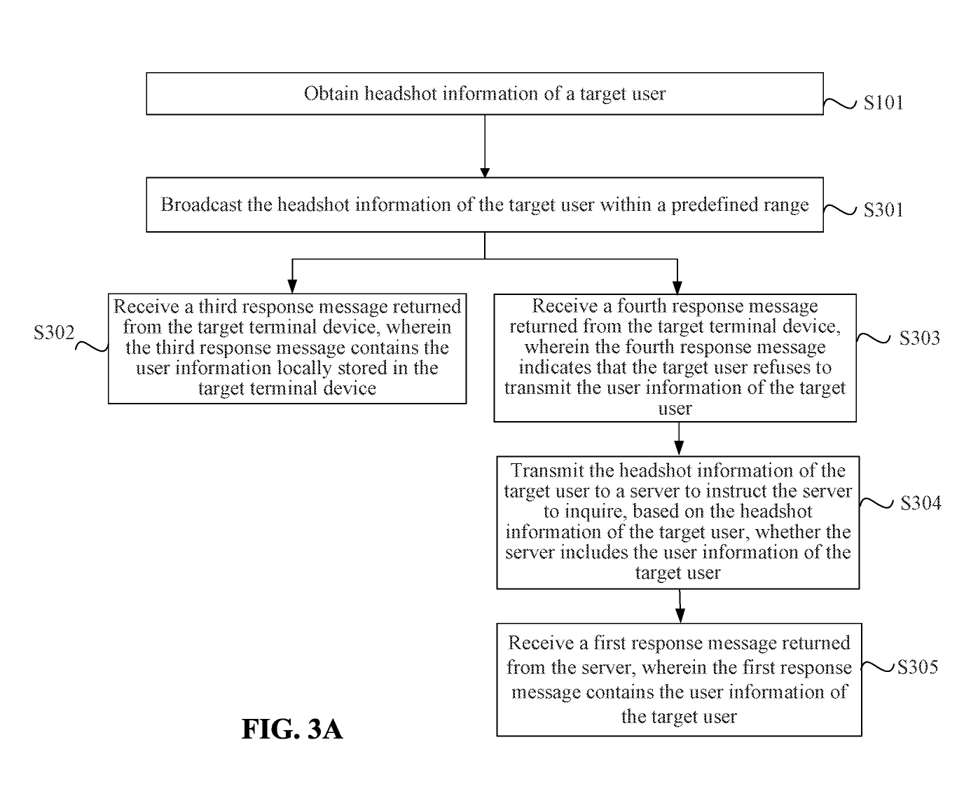

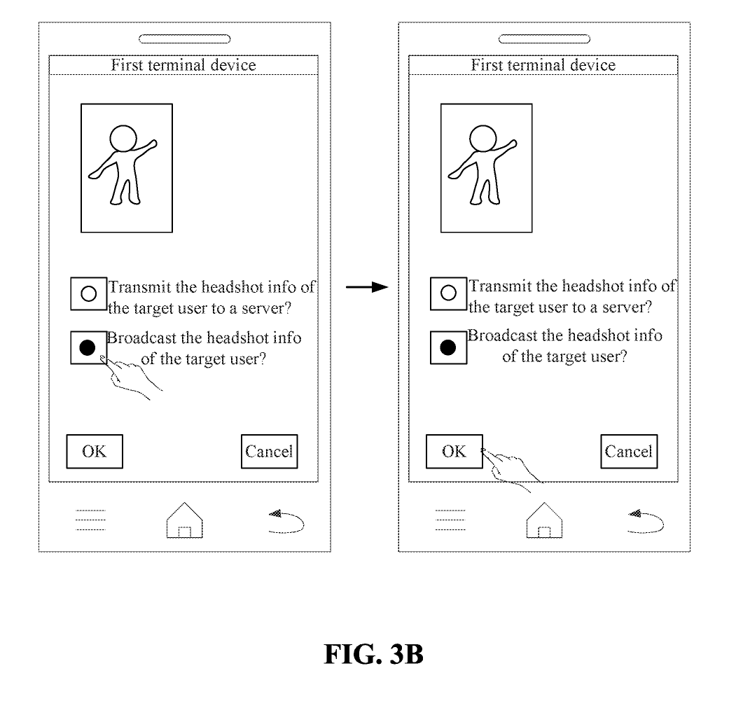

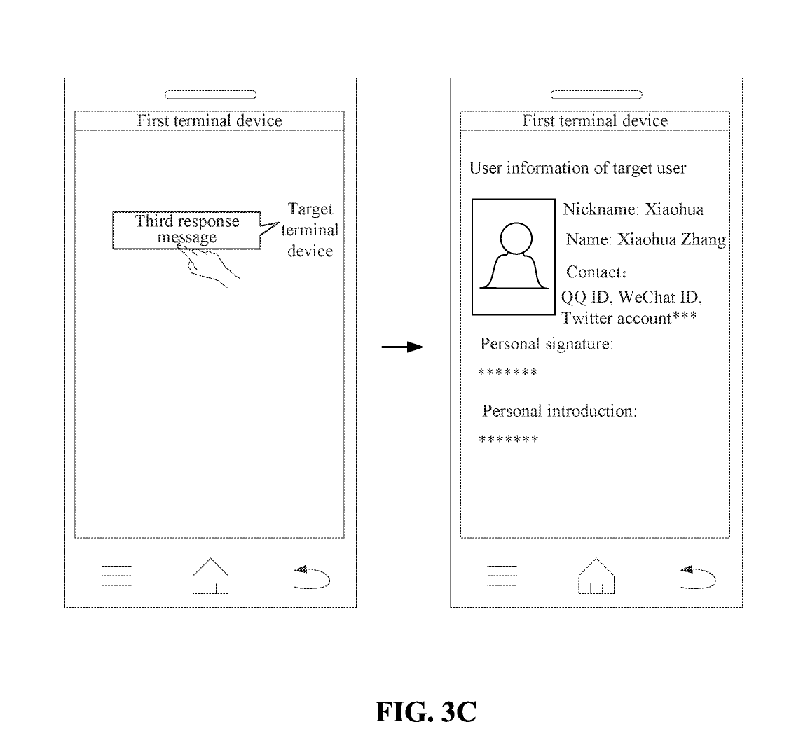

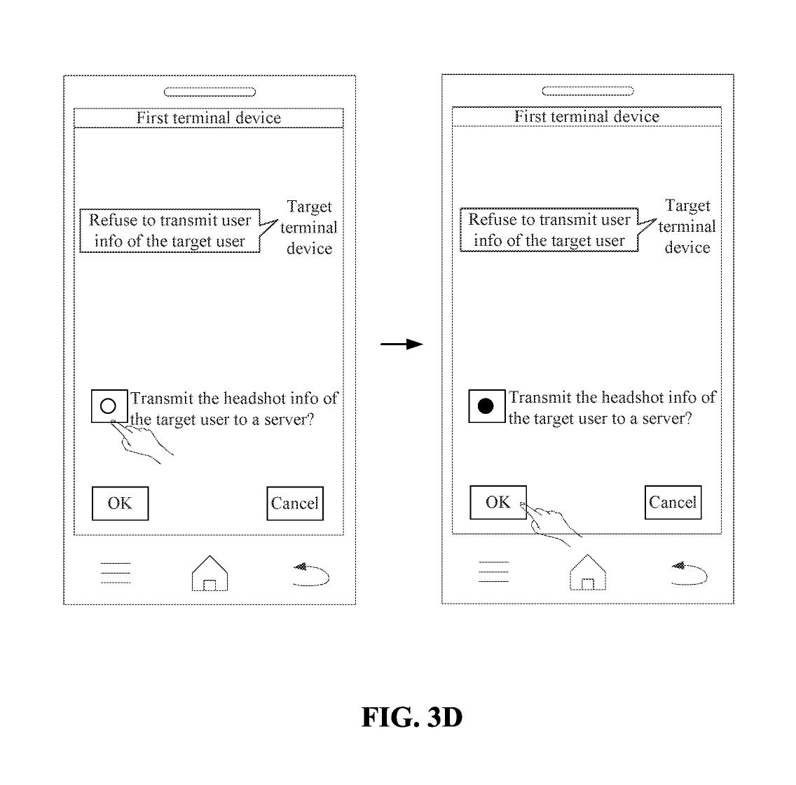

FIG. 3A shows a flowchart illustrating another method for acquiring user information according to another exemplary embodiment. FIGS. 3B-3D are schematic diagrams illustrating interfaces displayed when implementing the exemplary embodiment of FIG. 3A. On the basis of the embodiments described above, as shown in FIG. 3A, the detailed implementation of step S102 further includes the following steps S301-S305.

In step S301, the headshot information of the target user is broadcasted within a predefined range.

In some embodiments, a target terminal device corresponding to the target user is located within the predefined range.

In this step, the terminal device (i.e., “first terminal device”) broadcasts the headshot information of the target user within the predefined range. For example, as shown in FIG. 3B, the first terminal device broadcasts the headshot information after receiving a user input selecting a selection block of “broadcast the headshot info of the target user”, and a user input clicking the “OK” button. Optionally, the headshot information based user recognition software includes a broadcast function. In some embodiments, the headshot information of the target user obtained in step S101 may be broadcasted via Bluetooth®, WiFi®, etc. A terminal device (i.e., second terminal device) capable of receiving the headshot information of the target user within the predefined range may determine whether the second terminal device is the target terminal device corresponding to the target user based on the headshot information of the target user and headshot information stored in the second terminal device. The stored headshot information may uniquely identify a user having the second terminal device. If the second terminal device is the target terminal device, a third response message containing the user information locally stored in the target terminal device (i.e., the user information of the target user) is transmitted to the first terminal device. Correspondingly, the terminal device performs step S302.

In some embodiments, the second terminal device is preconfigured to be allowed to respond to other terminal devices with the user information of the user of the second terminal device. For example, when the first terminal device transmits to the second terminal device headshot information of the user of the second terminal device, the second terminal device automatically returns, to the first terminal device, a response message containing user information of the user of the second terminal device. In an alternative embodiment, before the second terminal device transmits the third response message to the first terminal device, the second terminal device informs its user of the following: a request transmitted from the first terminal device requests to acquire the user information of the user, is it allowable to transmit the user information to the first terminal device? If the user allows the second terminal device to transmit the user information to the first terminal device, the second terminal device transmits the third response message to the first terminal device. If the user declines to transmit user information to the first terminal device, the second terminal device transmits to the first terminal device a fourth response message, which indicates that the user of the second terminal device (i.e., the target device) declines to transmit the user information to the first terminal device. Correspondingly, the terminal device performs step S303 (discussed below).

Referring to FIG. 3A, in step S302, the third response message returned from the target terminal device is received. FIG. 3C shows an example of the third response message. The third response message contains the user information locally stored in the target terminal device.

In step S303, the fourth response message returned from the target terminal device is received. The fourth response message indicates that the target user declines to transmit the user information of the target user.

In some embodiments, after the terminal device does not acquire user information of the target user by broadcasting the headshot information of the target user, the terminal device further seeks to acquire the user information of the target user from a server. As shown in FIG. 3D, the terminal device displays an interface having a selection block of “transmit the headshot info of the target user to a server” for a user to select. After receiving a user input selecting this selection block, and a user input clicking an “OK” button, the terminal device transmits the headshot information of the target user to the server.

Referring to FIG. 3A, in step S304, the headshot information of the target user is transmitted to the server to instruct the server to inquire, based on the headshot information of the target user, whether the server includes the user information of the target user.

In some embodiments, the user information includes headshot information and profile information of the target user.

In some embodiments, the server stores the user information of at least one user (e.g., information that is permitted by the user to be disclosed to others). The stored user information may include headshot information of the user, profile information of the user, and the like. In this step, after the terminal device is operated to run headshot information based user recognition software, by transmitting the headshot information of the target user obtained in step S101 to the server, the server is enabled to inquire, based on the headshot information of the target user, whether the server includes the user information of the target user. If the server has stored the user information of the target user, the server transmits a first response message containing the user information of the target user. Correspondingly, the terminal device performs step S305 (discussed below). If the server has not stored the user information of the target user, the server transmits a second response message indicating that the server does not include the user information of the target user.

Referring to FIG. 3A, in step S305, a first response message returned from the server is received. The first response message contains the user information of the target user.

In some embodiments, the headshot information of the target user obtained in step S101 is encrypted to generate the encrypted headshot information of the target user. In step S301, encrypted headshot information of the target user is broadcasted within the predefined range. Optionally, in step S304, the encrypted headshot information of the target user is transmitted to the server, such that the server inquires whether the server includes the user information of the target user based on decrypted headshot information.

Methods of acquiring user information are provided in the present disclosure. By combining a method of broadcasting the headshot information of the target user so as to acquire the user information of the target user and a method of acquiring the user information of the target user from the server, the user information of the target user is accurately acquired, thereby improving the user experience.

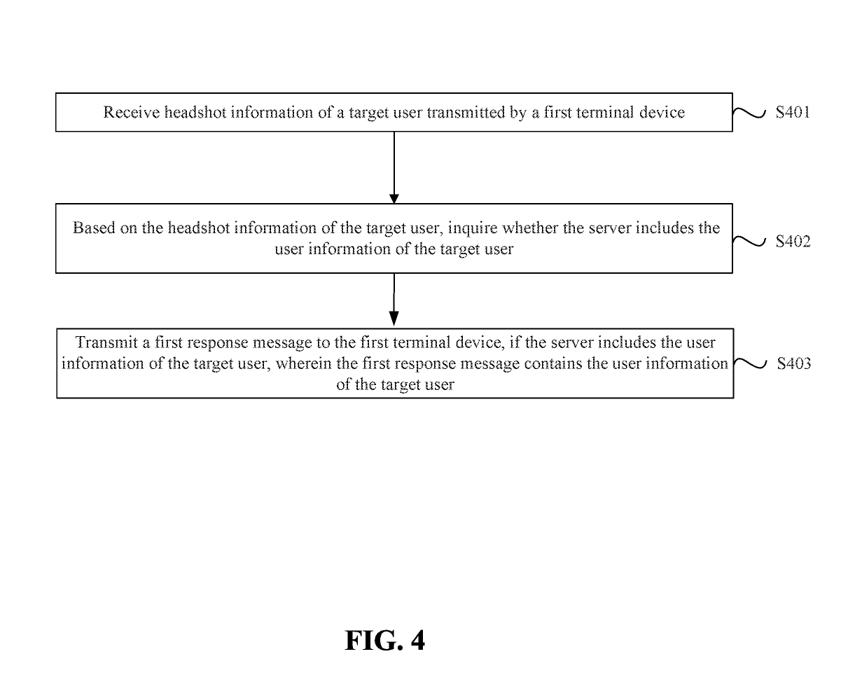

FIG. 4 shows a flowchart illustrating another method for acquiring user information according to another exemplary embodiment. This method may be applied in (e.g., performed by) a server for providing user information of a target user to various kinds of terminal devices which may have headshot information based user recognition software installed. As shown in FIG. 4, on the basis of the embodiments described above with respect to FIGS. 1A to 3A, the specific operations performed by the server include the following steps.

In step S401, the server receives headshot information of a target user transmitted by a first terminal device.

In step S402, based on the headshot information of the target user, the server inquires whether the server includes user information of the target user.

In some embodiments, the user information includes headshot information and profile information of the target user.

In step S403, if the server includes the user information of the target user, the server transmits a first response message to the first terminal device. The first response message contains the user information of the target user.

In some embodiments, the server stores the user information of at least one user (e.g., information that is allowed by the user to disclose to others). The stored user information includes headshot information of the user, profile information of the user, and the like. In step S401, the server receives the headshot information of the target user transmitted by the terminal device after the terminal device has been operated to run headshot information based user recognition software. Optionally, the headshot information of the target user received by the server is encrypted headshot information of the target user. In some embodiments, before step S401, the method further includes: acquiring and saving user information of at least one user, such that the server matches the received headshot information of the target user transmitted from any terminal device with the locally stored headshot information of users. In some embodiments, the server is a cloud server.

In step S402, based on the headshot information of the target user, the server inquires whether the server includes user information of the target user. Optionally, the server determines whether the server includes the user information of the target user by comparing the headshot information of the target user with the headshot information of at least one other user stored in the server. If both the headshot information of the target user and the headshot information of user A stored in the server identify the same user (i.e., the user A is the target user, which means the server contains the user information of the target user), the server transmits a first response message to the first terminal device, which includes the user information of the target user stored in the server (i.e., step S403). If the headshot information of the target user and the headshot information of user A stored in the server identify different users (i.e., the server does not contain the user information of the target user), the sever transmits a second response message to the first terminal device. The second response message indicates that the server does not include the user information of the target user.

In some embodiments, if the headshot information received by the server is encrypted headshot information, correspondingly, before step S402, the method further includes: decrypting the received encrypted headshot information of the target user to generate decrypted headshot information of the target user. Accordingly, step S402 includes: inquiring, based on the decrypted headshot information of the target user, whether the server includes the user information of the target user.

A method of acquiring user information is provided in the present disclosure. With the steps of receiving headshot information of a target user transmitted by a first terminal device, inquiring, based on the headshot information of the target user, whether the server includes the user information of the target user, and transmitting a first response message to the first terminal device, if the server includes the user information of the target user, the first terminal device is capable of accurately acquiring the user information of the target user, thereby improving the user experience.

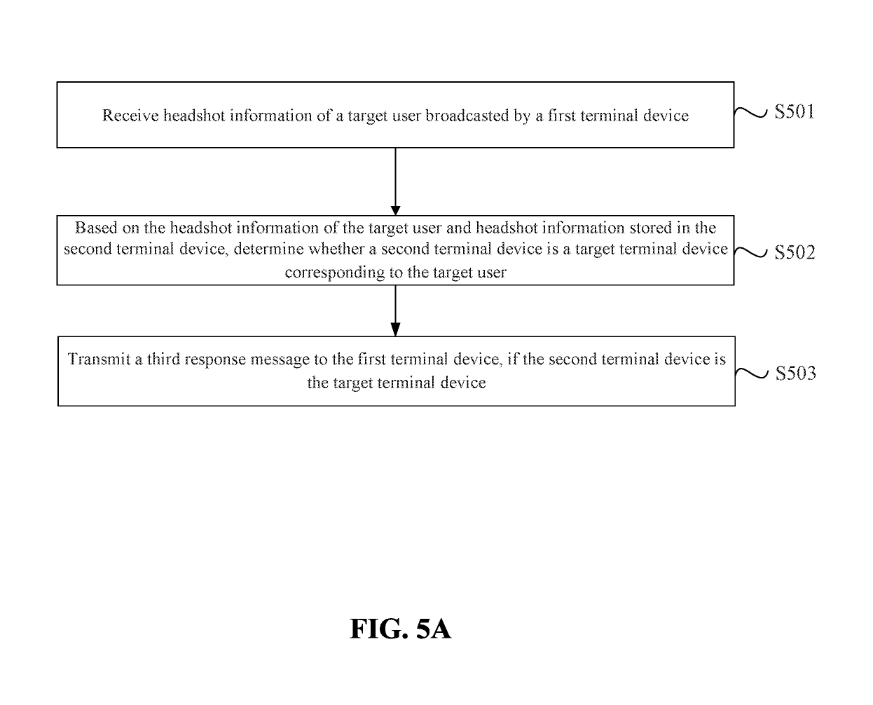

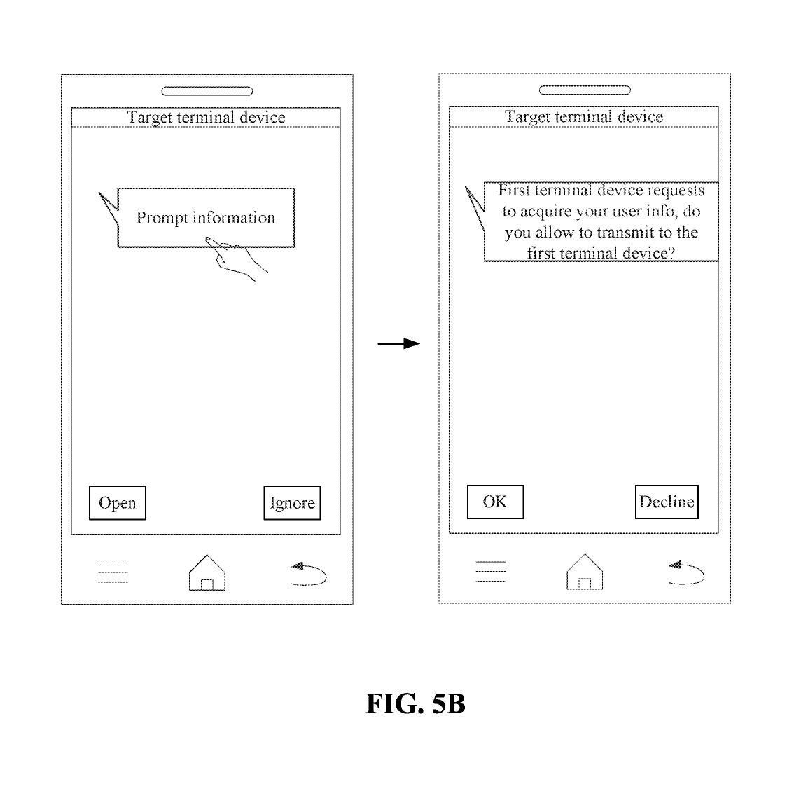

FIG. 5A shows a flowchart illustrating another method for acquiring user information according to another exemplary embodiment. FIG. 5B is a schematic diagram illustrating an interface displayed when implementing the exemplary embodiment of FIG. 5A. As shown in FIG. 5A, on the basis of the embodiments described above with respect to FIGS. 1A to 3A, the specific operations performed by a second terminal device (i.e., the terminal device that receives the headshot information of the target user broadcasted by the first terminal device) include the following steps.

In step S501, a second terminal device receives headshot information of a target user broadcasted by a first terminal device.

In step S502, based on the headshot information of the target user and headshot information stored in the second terminal device, the second terminal device determines whether the second terminal device is a target terminal device corresponding to the target user.

In step S503, if the second terminal device is the target terminal device, the second terminal device transmits a third response message to the first terminal device.

In some embodiments, the third response message contains the user information locally stored in the target terminal device, and the user information includes headshot information and profile information of the target user.

In some embodiments, in step S501, a second terminal device receives headshot information of a target user broadcasted by a first terminal device after the first terminal device has been operated to run headshot information based user recognition software. Optionally, the first terminal device may broadcast the headshot information of the target user within a predefined range via Bluetooth®, WiFi®, etc. Accordingly, the second terminal may receive the headshot information of the target user in a corresponding manner (i.e., in the same manner as that used for broadcasting by the first terminal device). Optionally, if the headshot information based user recognition software in the second terminal device has not been started when the second terminal device receives headshot information of a target user broadcasted by another terminal device (e.g., the first terminal device), the headshot information based user recognition software may be automatically started in the second terminal device, in order to determine whether the second terminal device is the target terminal device. Optionally, the headshot information of the target user received by the second terminal device is headshot information that has been encrypted by the first terminal device.

In step S502, determining whether the second terminal device is the target terminal device corresponding to the target user includes determining whether both the headshot information of the target user and the headshot information stored in the second terminal device identify the same user. If the headshot information of the target user and the headshot information stored in the second terminal device identify the same user (i.e., the second terminal device is the target terminal device), a third response message containing the user information locally stored in the target terminal device (i.e., the user information of the target user) is transmitted to the first terminal device (i.e., step S503).

In some embodiments, the second terminal device is preconfigured to be allowed to respond to other terminal devices with user information of a user of the second terminal device. For example, when the first terminal device transmits to the second terminal device headshot information of the user of the second terminal device, the second terminal device automatically returns, to the first terminal device, a response message containing user information of the user of the second terminal device. In an alternative embodiment, before the second terminal device transmits the third response message to the first terminal device, the second terminal device informs its user (i.e., the target user) of the following (as shown in FIG. 5B): “First terminal device requests to acquire your user info, do you allow to transmit it to the first terminal device?” If the user allows to transmit user information to the first terminal device, the second terminal device transmits the third response message to the first terminal device. If the user declines to transmit user information to the first terminal device (i.e., the second terminal device is the target terminal device, but the target user declines to transmit user information of the target user to the first terminal device), the second terminal device transmits to the first terminal device a fourth response message, which indicates that the user of the second terminal device (i.e., the target device) declines to transmit user information to the first terminal device.

In some embodiments, if the headshot information of the target user and the headshot information stored in the second terminal device identify two different users respectively (i.e., the second terminal device is not the target terminal device), the second terminal device does not transmit a response message to the first terminal device.

In some embodiments, if the headshot information received by the second terminal device is encrypted headshot information, correspondingly, before step S502, the method further includes: decrypting the received encrypted headshot information of the target user to generate decrypted headshot information of the target user. Accordingly, step S502 includes: determining whether a second terminal device is a target terminal device corresponding to the target user based on the decrypted headshot information of the target user and headshot information stored in the second terminal device.

A method of acquiring user information is provided in the present disclosure. With the steps of receiving headshot information of a target user broadcasted by a first terminal device, determining whether a second terminal device is a target terminal device corresponding to the target user based on the headshot information of the target user and headshot information stored in the second terminal device, and transmitting a third response message to the first terminal device if the second terminal device is the target terminal device, the first terminal device is capable of accurately acquiring the user information of the target user, thereby improving the user experience.

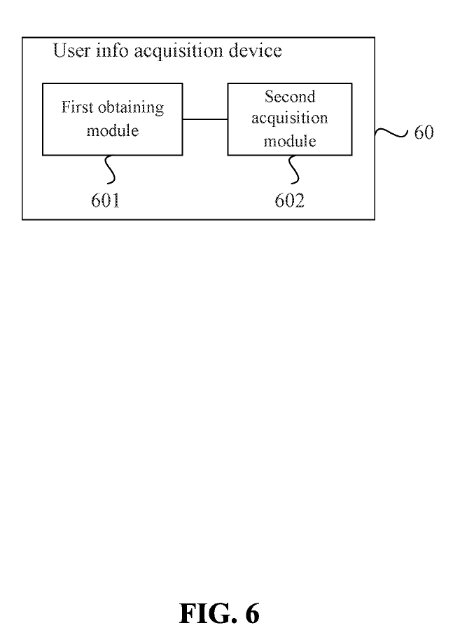

FIG. 6 is a block diagram of a device 60 for acquiring user information according to an exemplary embodiment. As shown in FIG. 6, user information acquisition device 60 includes: a first obtaining module 601 configured to obtain headshot information of a target user, and a second acquisition module 602 configured to acquire user information of the target user based on the headshot information obtained by the first obtaining module 601 and a predefined set of acquisition policies. The predefined set of acquisition policies includes at least one acquisition policy. Each of the acquisition policies indicates a respective approach to acquiring user information of the target user.

A user information acquisition device is provided in the present disclosure. By the first obtaining module 601 obtaining headshot information of a target user, and the second acquisition module 602 acquiring user information of the target user based on the headshot information obtained by the first obtaining module 601 and a predefined set of acquisition policies, the user information of the target user can be accurately acquired, thereby improving the user experience.

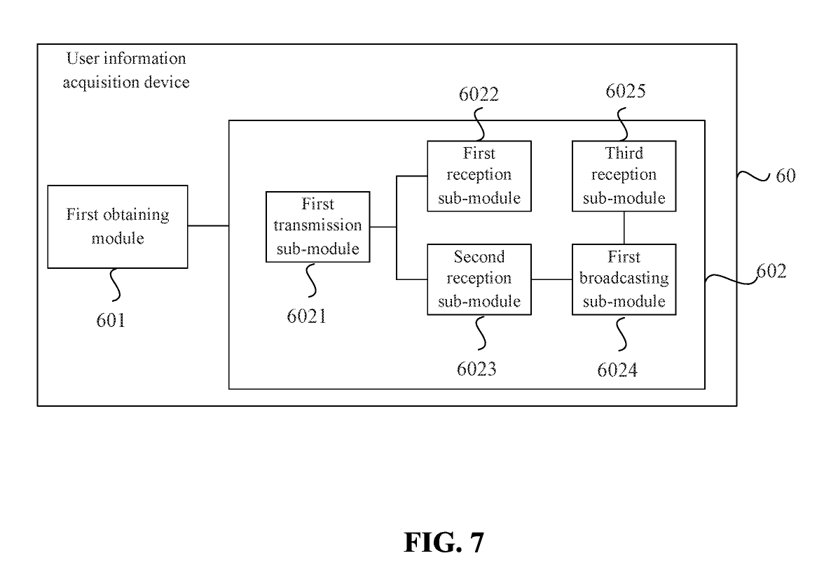

On the basis of the embodiment shown in FIG. 6, FIG. 7 is a block diagram of another device for acquiring user information according to another exemplary embodiment. Referring to FIG. 7, the second acquisition module 602 includes: a first transmission sub-module 6021 configured to transmit the headshot information obtained by the first obtaining module 601 to a server to instruct the server to inquire, based on the headshot information of the target user, whether the server includes the user information of the target user. The user information includes headshot information and profile information of the target user. The second acquisition module 602 also includes a first reception sub-module 6022 configured to receive a first response message returned from the server. The first response message contains the user information of the target user.

In some embodiments, the second acquisition module 602 further includes: a second reception sub-module 6023 configured to receive a second response message returned from the server. The second response message indicates that the server does not include the user information of the target user. The second acquisition module 602 also includes a first broadcasting sub-module 6024 configured to broadcast the headshot information obtained by the first obtaining module 601 within a predefined range in which a target terminal device corresponding to the target user is located. The second acquisition module 602 further includes a third reception sub-module 6025 configured to receive a third response message returned from the target terminal device. The third response message contains the user information locally stored in the target terminal device.

A user information acquisition device is provided in the present disclosure. By combining a method of acquiring the user information of the target user with a method of acquiring the user information of the target user by broadcasting the headshot information of the target user, the second acquisition module 602 accurately acquires the user information of the target user, thereby improving the user experience.

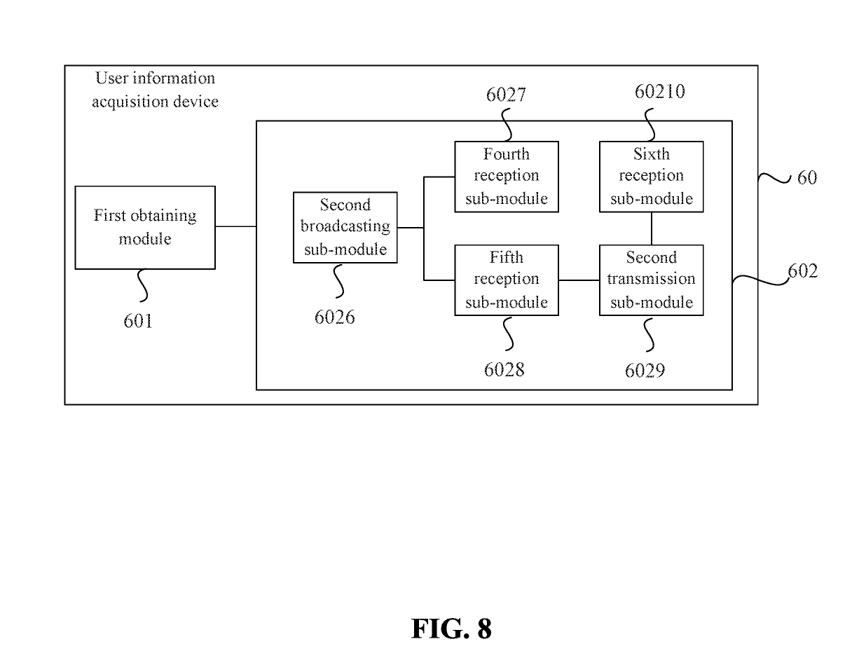

On the basis of the embodiment shown in FIG. 6, FIG. 8 is a block diagram of another device for acquiring user information according to another exemplary embodiment. Referring to FIG. 8, the second acquisition module 602 includes: a second broadcasting sub-module 6026 configured to broadcast the headshot information obtained by the first obtaining module 601 within a predefined range in which a target terminal device corresponding to the target user is located. The second acquisition module 602 also includes a fourth reception sub-module 6027 configured to receive a third response message returned from the target terminal device. The third response message contains the user information locally stored in the target terminal device.

In some embodiments, the second acquisition module 602 further includes: a fifth reception sub-module 6028 configured to receive a fourth response message returned from the target terminal device. The fourth response message indicates that the target user declines to transmit the user information of the target user. The second acquisition module 602 also includes a second transmission sub-module 6029 configured to transmit the headshot information obtained by the first obtaining module 601 to a server to instruct the server to inquire, based on the headshot information of the target user, whether the server includes the user information of the target user. The user information includes headshot information and profile information of the target user. The second acquisition module 602 further includes a sixth reception sub-module 60210 configured to receive a first response message returned from the server. The first response message contains the user information of the target user.

A user information acquisition device is provided in the present disclosure. By combining a method of acquiring the user information of the target user by broadcasting the headshot information of the target user in combination with a method of acquiring the user information of the target user, the second acquisition module 602 accurately acquires the user information of the target user, thereby improving the user experience.

Any of the user information acquisition devices provided in the above embodiments may be used to implement the technical solutions of the methods shown in FIGS. 1A, 2A, and 3A. The principles of the devices and the technical effects achieved by the devices are similar to those discussed above. That is, through obtaining headshot information of the target user, and by combining a method of acquiring the user information of the target user by broadcasting the headshot information of the target user with a method of acquiring the user information of the target user from the server, the user information of the target user can be accurately acquired, thereby improving the user experience.

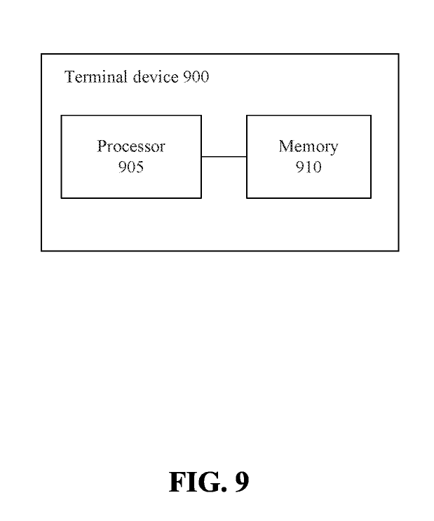

The above descriptions illustrate internal functional modules and schematic structures of devices for acquiring user information. Each of these devices can be implemented in or as a terminal device (optionally, the terminal device may be the first terminal device). FIG. 9 is a block diagram of a terminal device 900 according to an exemplary embodiment. Referring to FIG. 9, the terminal device 900 is specifically implemented to include at least a processor 905 and a memory 910 for storing instructions executable by the processor. The processor 905 is configured to execute the instructions to obtain headshot information of a target user; and acquire user information of the target user based on the headshot information of the target user and a predefined set of acquisition policies. The predefined set of acquisition policies includes at least one acquisition policy. Each of the acquisition policies indicates a respective approach to acquiring user information of the target user.

In the above embodiments of the terminal device, the processor (e.g., processor 905) may be a Central Processing Unit (CPU), or other general-purpose processor, Digital Signal Processing (DSP), Application Specific Integrated Circuit (ASIC), or the like. The general-purpose processor may be microprocessor or the processor may be another common processor. The memory (e.g., memory 910) may be a read-only memory (ROM), random access memory (RAM), flash memory, hard disk or solid-state disk. A SIM card is also known as Subscriber Identity Module or smart card, and a digital mobile phone may be provided with such a SIM card. In some embodiments, the following contents may be stored in a computer chip (e.g., a memory or a SIM card): information of the owner of the digital mobile phone, encryption key(s), telephone book, etc. The steps of the disclosed methods may be performed by a hardware processor (e.g., processor 905), or may be performed by a combination of hardware and software modules in the processor (e.g., processor 905).

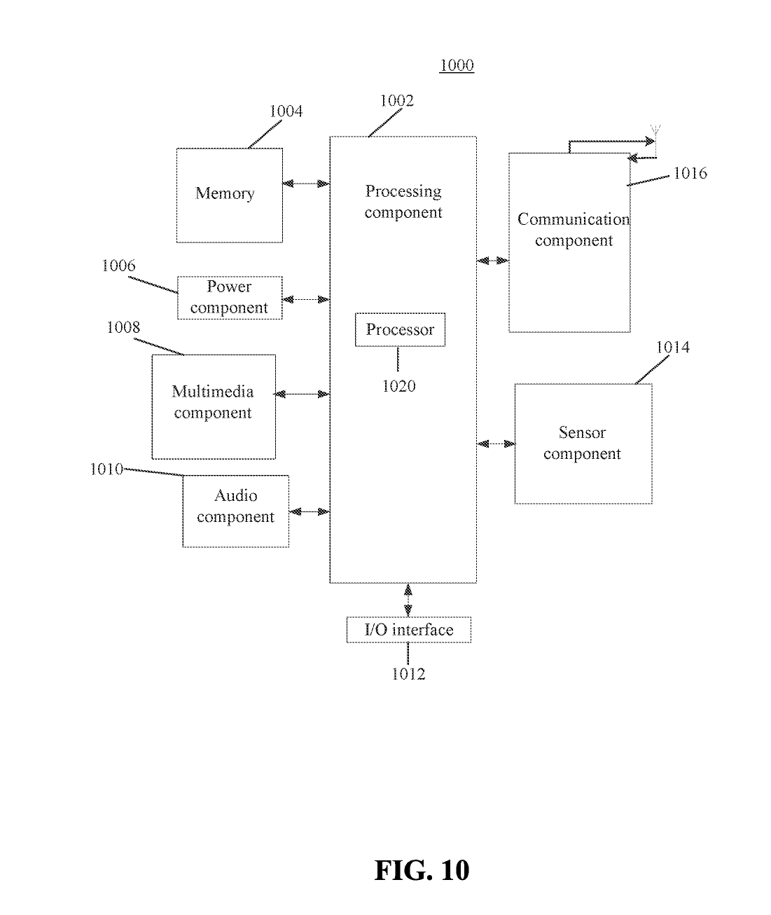

FIG. 10 is a block diagram of a terminal device 1000 according to an exemplary embodiment. Terminal device 1000 may be a user information acquisition device, such as mobile phone, a computer, a tablet computer, etc., capable of acquiring user information of a target user. Referring to FIG. 10, the terminal device 1000 includes one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 is configured to control overall operations of the terminal device 1000, such as operations associated with display and/or data communications, multimedia operations, and recording operations. The processing component 1002 includes one or more processors 1020 configured to execute instructions to perform all or part of the above-described methods. Moreover, the processing component 1002 includes one or more modules configured to facilitate the interaction between the processing component 1002 and other components. In some embodiments, the processing component 1002 includes a multimedia module to facilitate the interaction between the multimedia component 1008 and the processing component 1002.

The memory 1004 is configured to store various types of data to support the operation of the terminal device 1000. Examples of such data include instructions, various data, messages, pictures, video, etc., for applications or methods operated on the terminal device 1000. The memory 1004 is implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic, or an optical disk.

The power component 1006 is configured to provide power to various components of the terminal device 1000. The power component 1006 may include a power management system, one or more power sources, and any other components associated with the generation, management, and distribution of power in the terminal device 1000.

The multimedia component 1008 includes a screen providing an output interface between the terminal device 1000 and the user. In some embodiments, the screen may include a liquid crystal display and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action.

The audio component 1010 is configured to output and/or input audio signals. For example, in some embodiments, the audio component 1010 includes a microphone configured to receive an external audio signal when the terminal device 1000 is in an operation mode, such as a call mode, a recording mode, and a voice recognition mode. The received audio signal may be further stored in the memory 1004 or transmitted via the communication component 1016. In some embodiments, the audio component 1010 further includes a speaker configured to output audio signals.

The I/O interface 1012 is configured to provide an interface between the processing component 1002 and peripheral interface modules, such as a keyboard, a click wheel, buttons, and the like.

The sensor component 1014 includes one or more sensors configured to provide status assessments of various aspects of the terminal device 1000. For example, in some embodiments, the sensor component 1014 detects an open/closed status of the terminal device 1000, relative positioning of components, e.g., the display and the keypad, of the terminal device 1000, a change in position of the terminal device 1000 or a component of the terminal device 1000, a presence or absence of user contact with the terminal device 1000, an orientation or an acceleration/deceleration of the terminal device 1000, and a change in temperature of the terminal device 1000. The sensor component 1014 may include a proximity sensor configured to detect the presence of nearby objects without any physical contact. The sensor component 1014 may include a light sensor, such as a CMOS or CCD image sensor, for use in imaging applications. In some embodiments, the sensor component 1014 may also include an accelerometer sensor, a gyroscope sensor, a magnetic sensor, a pressure sensor, or a temperature sensor.

The communication component 1016 is configured to facilitate communication, wired or wirelessly, between the terminal device 1000 and other devices. The terminal device 1000 can access a wireless network based on a communication standard, such as WiFi, 2G, 3G, 4G, or a combination thereof. In one embodiment, the communication component 1016 receives a broadcast signal or broadcast associated information from an external broadcast management system via a broadcast channel In one embodiment, the communication component 1016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the terminal device 1000 is implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In some embodiments, there is also provided a non-transitory computer-readable storage medium including instructions, such as included in the memory 1004, executable by the processor 1020 in the terminal device 1000, for performing the above-described methods. For example, the non-transitory computer-readable storage medium may include a ROM, a RAM, a CD-ROM, a magnetic tape, a floppy disc, an optical data storage device, and the like.

There is provided a non-transitory computer-readable storage medium including instructions that, when executed by the processing component within the user information acquisition device, cause the user information acquisition device to perform a method for acquiring user information. The method includes: obtaining headshot information of a target user; and acquiring user information of the target user based on the headshot information of the target user and a predefined set of acquisition policies. The predefined set of acquisition policies includes at least one acquisition policy. Each of the acquisition policies indicates a respective approach to acquiring user information of the target user.

In some embodiments, acquiring the user information of the target user includes: transmitting the headshot information of the target user to a server to instruct the server to inquire, based on the headshot information of the target user, whether the server includes the user information of the target user. The user information includes headshot information and profile information of the target user. Acquiring the user information of the target user also includes receiving a first response message returned from the server. The first response message contains the user information of the target user.

In some embodiments, after transmitting the headshot information of the target user to the server, the method includes: receiving a second response message returned from the server. The second response message indicates that the server does not include the user information of the target user. The method also includes broadcasting the headshot information of the target user within a predefined range in which a target terminal device corresponding to the target user is located. The method further includes receiving a third response message returned from the target terminal device. The third response message contains the user information locally stored in the target terminal device.

In some embodiments, acquiring the user information of the target user includes: broadcasting the headshot information of the target user within a predefined range in which a target terminal device corresponding to the target user is located; and receiving a third response message returned from the target terminal device. The third response message contains the user information locally stored in the target terminal device.

In some embodiments, after broadcasting the headshot information of the target user within the predefined range, the method includes: receiving a fourth response message returned from the target terminal device. The fourth response message indicates that the target user declines to transmit the user information of the target user. The method also includes transmitting the headshot information of the target user to a server to instruct the server to inquire, based on the headshot information of the target user, whether the server includes the user information of the target user. The user information includes headshot information and profile information of the target user. The method also includes receiving a first response message returned from the server. The first response message contains the user information of the target user.

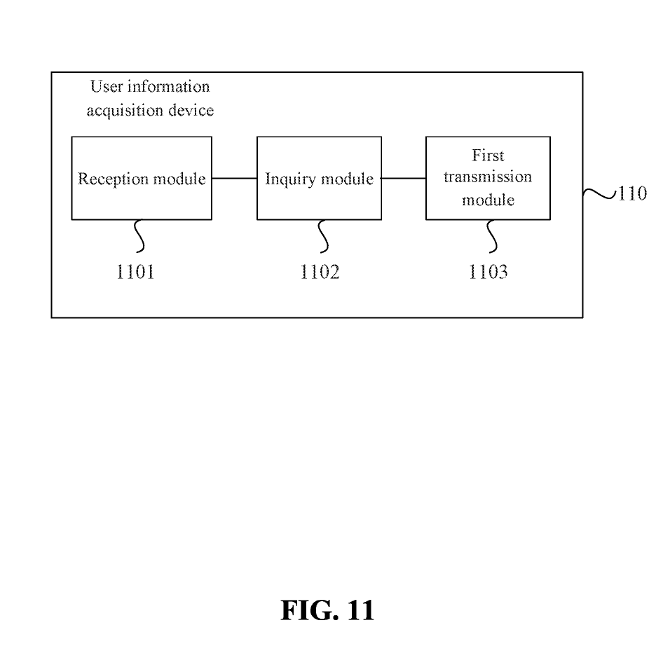

FIG. 11 is a block diagram of another device for acquiring user information according to another exemplary embodiment. As shown in FIG. 11, a user information acquisition device 110 includes: a reception module 1101 configured to receive headshot information of a target user transmitted by a first terminal device. The user information acquisition device 110 may be implemented as or in a server disclosed herein. The user information acquisition device 110 also includes an inquiry module 1102 configured to inquire, based on the headshot information received by the reception module 1101, whether the server includes the user information of the target user. The user information includes headshot information and profile information of the target user. The user information acquisition device 110 also includes a first transmission module 1103 configured to transmit a first response message to the first terminal device, if the inquiry module 1102 determines that the server includes the user information of the target user. The first response message contains the user information of the target user.

In the user information acquisition device 110, the reception module 1101 receives headshot information of a target user transmitted by a first terminal device. Based on the headshot information received by the reception module 1101, the inquiry module 1102 inquires whether a server includes the user information of the target user. If the inquiry module 1102 determines that the server includes the user information of the target user, the first transmission module 1103 transmits to the first terminal device a first response message containing the user information of the target user. Accordingly, the first terminal device acquires accurate user information of the target user. As a result, the user experience is improved.

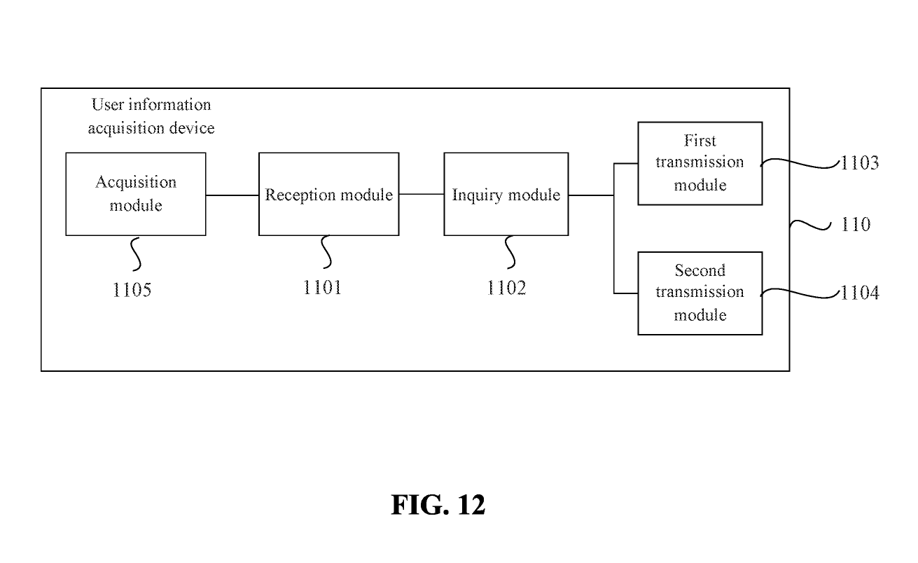

On the basis of the above embodiment shown in FIG. 11, FIG. 12 is a block diagram of another device for acquiring user information according to another exemplary embodiment. Referring to FIG. 12, the device 110 further includes a second transmission module 1104 configured to transmit a second response message to the first terminal device, if the inquiry module 1102 determines that the server does not include the user information of the target user. The second response message indicates that the server does not include the user information of the target user.

In some embodiments, the device 110 includes an acquisition module 1105 configured to acquire and save the user information of at least one user.

Any of the user information acquisition devices provided in the above embodiments may be used to implement the technical solution of the method shown in FIG. 4. The principle of the user information acquisition devices and the technical effects achieved by the user information acquisition devices are similar to those discussed above. That is, through receiving headshot information of a target user transmitted by a first terminal device, inquiring, according to the headshot information received by the reception module 1101, whether the server includes the user information of the target user, and if the inquiry module 1102 determines that the server includes the user information of the target user, transmitting to the first terminal device a first response message containing the user information of the target user, the first terminal device can acquire accurate user information of the target user. As a result, the user experience is improved.

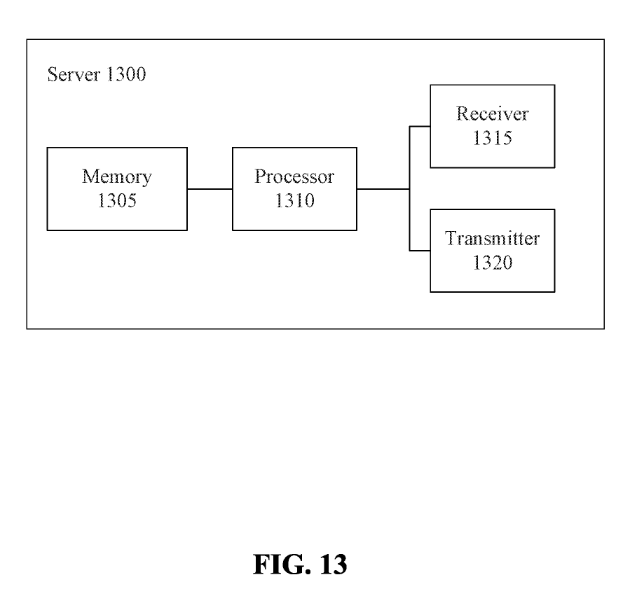

The above descriptions illustrate internal functional modules and schematic structures of devices for acquiring user information. The devices may be implemented in or as a server. FIG. 13 is a block diagram of a server 1300 according to an exemplary embodiment. Referring to FIG. 13, the server 1300 is specifically implemented to include at least one of a transmitter 1320, a receiver 1315, a processor 1310, and a memory 1305 for storing instructions executable by the processor 1310. The receiver 1315 is configured to receive headshot information of a target user transmitted by a first terminal device. The processor 1310 is configured to inquire, according to the headshot information of the target user, whether the server 1300 includes the user information of the target user. The user information includes headshot information and profile information of the target user. The transmitter 1320 is configured to transmit a first response message to the first terminal device, if the server 1300 includes the user information of the target user. The first response message contains the user information of the target user.

In the above embodiment of the server 1300, the processor 1310 may be a Central Processing Unit (CPU), or other general-purpose processors, Digital Signal Processing (DSP), Application Specific Integrated Circuit (ASIC), or the like. The general-purpose processor may be microprocessor or the processor may be other common processor, etc. The memory 1305 may be read-only memory (ROM), random access memory (RAM), flash memory, hard disk, or solid-state disk. The steps of the disclosed methods may be performed by a hardware processor (e.g., 1310), or may be performed by a combination of hardware and software modules in the processor 1310.

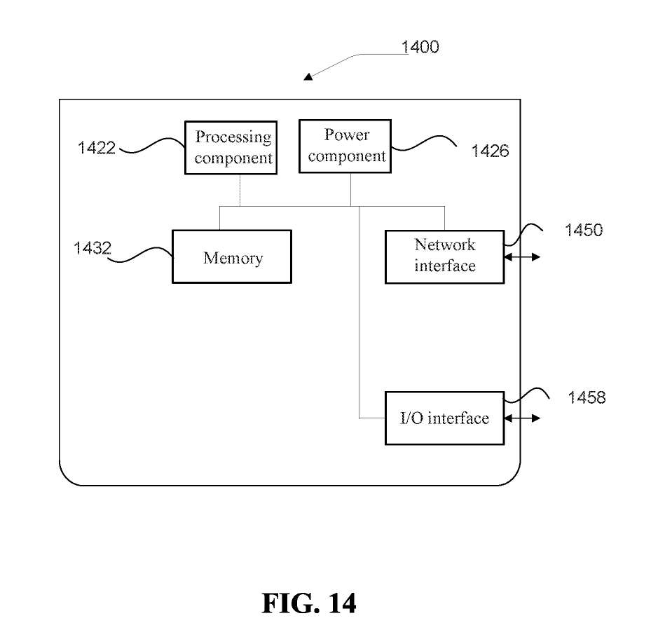

FIG. 14 is a block diagram of a server 1400 according to another exemplary embodiment. Server 1400 may be an embodiment of any of the servers discussed above, including server 1300. Referring to FIG. 14, the server 1400 includes a processing component 1422 (which may further include one or more processors), and a memory 1432 representative of memory resources for storing instructions executable by the processing component 1422 (e.g., an application program). The application program stored in the memory 1432 includes one or more modules, each of which corresponds to a set of instructions. Further, the processing component 1422 is configured to execute the instructions to perform steps of the method for acquiring user information shown in FIG. 4.

The device 1400 also includes a power component 1426 configured to perform power supply management of server 1400, a wired or wireless network interfaces 1450 configured to connect the server 1400 to the network, and an input/output interface 1458. The server 1400 may operate with an operating system (such as Windows Server™, Mac OS X™, Unix™, Linux™, FreeBSD™, or the like) stored in the memory 1432.

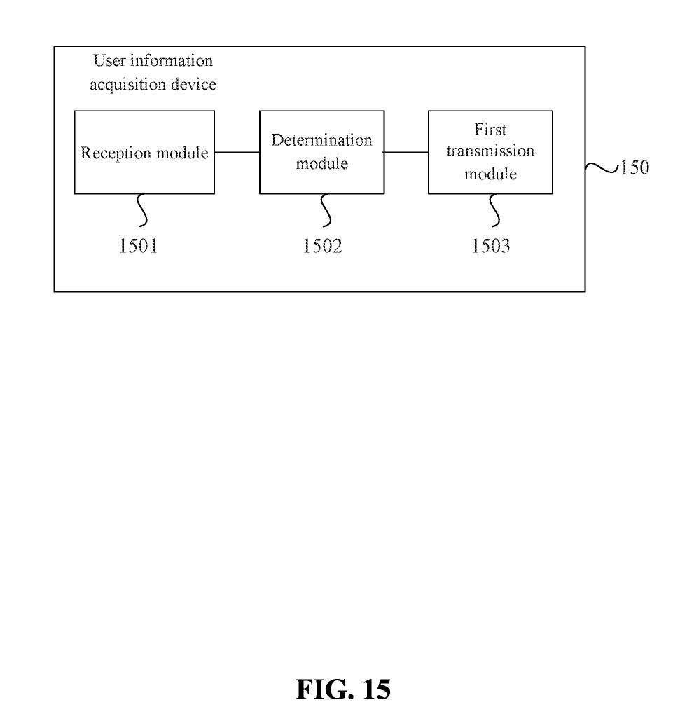

FIG. 15 is a block diagram of another device 1500 for acquiring user information according to another exemplary embodiment. As shown in FIG. 15, the user information acquisition device 150 includes a reception module 1501 configured to receive headshot information of a target user broadcasted by a first terminal device. The user information acquisition device 150 also includes a determination module 1502 configured to determine whether a second terminal device is a target terminal device corresponding to the target user, based on the headshot information received by the reception module 1501 and headshot information stored in the second terminal device. The user information acquisition device 150 further includes a first transmission module 1503 configured to transmit a third response message to the first terminal device, if the determination module 1502 determines that the second terminal device is the target terminal device. The third response message contains the user information locally stored in the target terminal device, and the user information includes headshot information and profile information of the target user.

In the user information acquisition device 150, the reception module 1501 receives headshot information of a target user broadcasted by a first terminal device. The determination module 1502 determines whether a second terminal device is a target terminal device corresponding to the target user based on the headshot information received by the reception module 1501 and headshot information stored in the second terminal device. If the determination module 1502 determines that the second terminal device is the target terminal device, the first transmission module 1503 transmits a third response message to the first terminal device. The third response message contains the user information locally stored in the target terminal device. Accordingly, the first terminal device can acquire accurate user information of the target user, thereby improving the user experience.

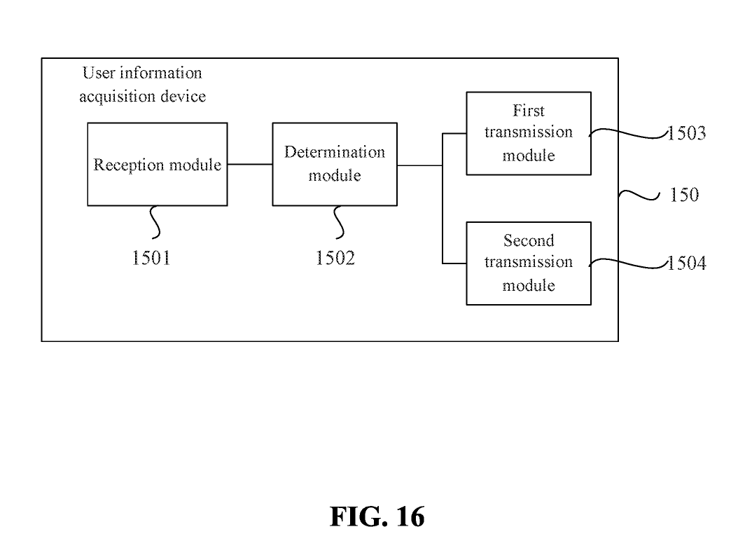

On the basis of the above embodiment shown in FIG. 15, FIG. 16 is a block diagram of another device for acquiring user information according to another exemplary embodiment. Referring to FIG. 16, the device 150 further includes a second transmission module 1504 configured to transmit a fourth response message to the first terminal device, if the determination module 1502 determines that the second terminal device is the target terminal device and the target user declines to transmit the user information of the target user to the first terminal device. The fourth response message indicates that the target user declines to transmit the user information of the target user.

Any of the user information acquisition devices provided in the above embodiments may be used to implement the technical solution of the method shown in FIG. 5. The principle and the technical effects associated with the devices are similar to those discussed above. That is, through receiving headshot information of a target user broadcasted by a first terminal device, determining whether a second terminal device is a target terminal device corresponding to the target user, based on the headshot information received by the reception module and headshot information stored in the second terminal device, and if the determination module determines that the second terminal device is the target terminal device, transmitting to the first terminal device, a third response message containing the user information locally stored in the target terminal device, the first terminal device can acquire accurate user information of the target user. As a result, the user experience is improved.

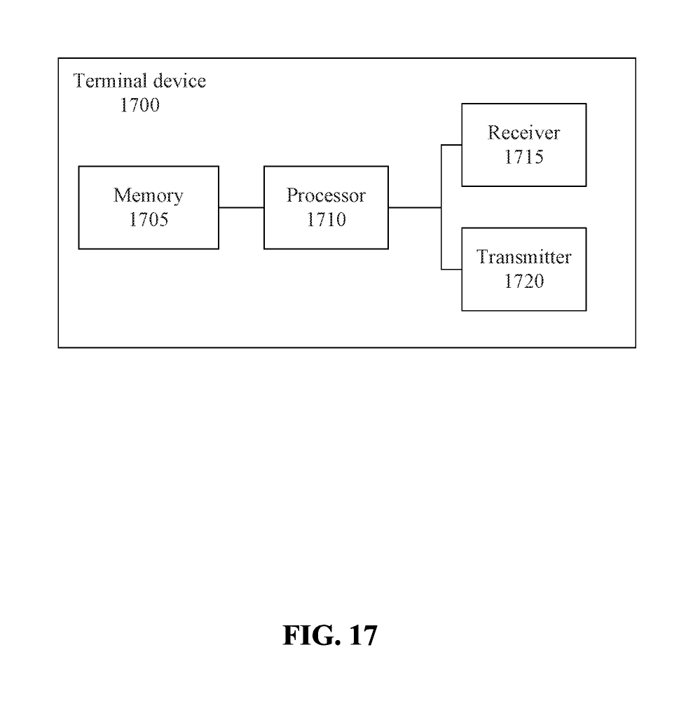

The above descriptions illustrate internal functional modules and schematic structures of devices for acquiring user information. The devices may be implemented in or as a terminal device (the terminal device may be the second terminal device). FIG. 17 is a block diagram of another terminal device according to another exemplary embodiment. Referring to FIG. 17, terminal device 1700 is implemented to include at least one of a transmitter 1720, a receiver 1715, a processor 1710, and a memory 1705 for storing instructions executable by the processor 1710. The receiver 1715 is configured to receive headshot information of a target user broadcasted by a first terminal device. The processor 1710 is configured to determine whether a second terminal device is a target terminal device corresponding to the target user, based on the headshot information received by the reception module and headshot information stored in the second terminal device. The transmitter 1720 is configured to transmit a third response message to the first terminal device, if the determination module determines that the second terminal device is the target terminal device. The third response message contains the user information locally stored in the target terminal device, and the user information includes headshot information and profile information of the target user.

In some embodiments, the terminal device 1700 may include components included in the embodiment shown in FIG. 10, the descriptions of which are not repeated.

In exemplary embodiments, there is also provided a non-transitory computer-readable storage medium including instructions, such as a memory containing instructions, which are executable by a processor in a terminal device for performing the above-described methods. For example, the non-transitory computer-readable storage medium may include a ROM, a RAM, a CD-ROM, a magnetic tape, a floppy disc, an optical data storage device, and the like.

There is provided a non-transitory computer-readable storage medium including instructions that, when executed by a processing component within a user information acquisition device, cause the user information acquisition device to perform a method for acquiring user information. The method includes receiving headshot information of a target user broadcasted by a first terminal device. The method also includes determining whether a second terminal device is a target terminal device corresponding to the target user, based on the headshot information of the target user and headshot information stored in the second terminal device. The method also includes transmitting a third response message to the first terminal device, if the second terminal device is the target terminal device. The third response message contains the user information locally stored in the target terminal device, and the user information includes headshot information and profile information of the target user.

In one embodiment, after determining whether the second terminal device is the target terminal device corresponding to the target user, the method further includes: transmitting a fourth response message to the first terminal device, if the second terminal device is the target terminal device and the target user declines to transmit the user information of the target user to the first terminal device. The fourth response message indicates that the target user declines to transmit the user information of the target user.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. The specification and embodiments are merely considered to be exemplary and the substantive scope and spirit of the disclosure is limited only by the appended claims.

It will be appreciated that the inventive concept is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for acquiring user information, comprising:
obtaining headshot information of a target user; and
acquiring user information of the target user based on the headshot information of the target user and a predefined set of acquisition policies, wherein the predefined set of acquisition policies includes at least one acquisition policy, and each of the acquisition policies indicates a respective approach to acquiring the user information of the target user.

2. The method of claim 1, wherein acquiring the user information of the target user comprises:
transmitting the headshot information of the target user to a server to instruct the server to inquire, based on the headshot information of the target user, whether the server includes the user information of the target user, wherein the user information includes headshot information and profile information of the target user.

3. The method of claim 2, further comprising:
receiving a response message returned from the server, wherein the response message from the server contains the user information of the target user.

4. The method of claim 2, further comprising:
receiving a response message returned from the server, wherein the response message from the server indicates that the server does not include the user information of the target user;
broadcasting the headshot information of the target user within a predefined range in which a target terminal device corresponding to the target user is located; and
receiving a response message returned from the target terminal device, wherein the response message from the target terminal device contains the user information locally stored in the target terminal device.

5. The method of claim 1, wherein acquiring the user information of the target user comprises:
broadcasting the headshot information of the target user within a predefined range in which a target terminal device corresponding to the target user is located.

6. The method of claim 5, further comprising:
receiving a response message returned from the target terminal device, wherein the response message from the target terminal device contains the user information locally stored in the target terminal device.

7. The method of claim 5, further comprising:
receiving a response message returned from the target terminal device, wherein the response message from the target terminal device indicates that the target user declines to transmit the user information of the target user;
transmitting the headshot information of the target user to a server to instruct the server to inquire, based on the headshot information of the target user, whether the server includes the user information of the target user, wherein the user information includes headshot information and profile information of the target user; and
receiving a response message returned from the server, wherein the response message from the server contains the user information of the target user.

8. A device for acquiring user information, the device being a first terminal device and comprising:
a processor; and
a memory for storing instructions executable by the processor,
wherein the processor is configured to execute the instructions to:
obtain headshot information of a target user; and
acquire user information of the target user based on the headshot information of the target user and a predefined set of acquisition policies, wherein the predefined set of acquisition policies includes at least one acquisition policy, and each of the acquisition policies indicates a respective approach to acquiring user information of the target user.

9. The device of claim 8, wherein the processor is further configured to execute the instructions to:
transmit the headshot information to a server to instruct the server to inquire, based on the headshot information of the target user, whether the server includes the user information of the target user, wherein the user information includes headshot information and profile information of the target user.

10. The device of claim 9, wherein the processor is further configured to execute the instructions to:
receive a response message returned from the server, wherein the response message from the server contains the user information of the target user.

11. The device of claim 9, wherein the processor is further configured to execute the instructions to:
receive a response message returned from the server, wherein the response message from the server indicates that the server does not include the user information of the target user;
broadcast the headshot information within a predefined range in which a target terminal device corresponding to the target user is located; and
receive a response message returned from the target terminal device, wherein the response message from the target terminal device contains the user information locally stored in the target terminal device.

12. The device of claim 8, wherein the processor is further configured to execute the instructions to:
broadcast the headshot information within a predefined range in which a target terminal device corresponding to the target user is located.

13. The device of claim 12, wherein the processor is further configured to execute the instructions to:
receive a response message returned from the target terminal device, wherein the response message from the target terminal device contains the user information locally stored in the target terminal device.

14. The device of claim 12, wherein the processor is further configured to execute the instructions to:
receive a response message returned from the target terminal device, wherein the response message from the target terminal device indicates that the target user declines to transmit the user information of the target user;
transmit the headshot information to a server to instruct the server to inquire, based on the headshot information of the target user, whether the server includes the user information of the target user, wherein the user information includes headshot information and profile information of the target user; and
receive a response message returned from the server, wherein the response message from the server contains the user information of the target user.

15. A non-transitory computer-readable storage medium having stored therein instructions that, when executed by a processor of a device, cause the device to perform the method of claim 1.
